(19) United States
(12) Patent Application Publication
(10) Pub. No.: US 2026/0346816 A1
(43) Pub. Date: Nov. 5, 2026

(54) MACHINE SYSTEM CONFIGURED WITH SWAPPABLE POWER PACKS AND METHOD OF OPERATING SAME

(71) Applicant: Caterpillar Inc., Peoria, IL (US)

(72) Inventor: Evan Earl Jacobson, Edwards, IL (US)

(73) Assignee: Caterpillar Inc., Peoria, IL (US)

(21) Appl. No.: 19/197,257

(22) Filed: May 2, 2025

(51) Int. Cl. B60S 5/06; B60L 53/80; B60R 16/033; H01M 50/249

(52) U.S. Cl. CPC B60S 5/06; H01M 50/249; B60L 53/80; B60R 16/033; H01M 2220/20

(57) ABSTRACT

A machine system includes a plurality of machines each having a frame, ground-engaging elements, and an electrical power system. The machine system also includes a plurality of power packs interchangeable for installation on any one of a plurality of power pack installation stations of the plurality of machines. The machine system also includes a power pack loading system such as a guide rail loading system arranged for swapping replacement power packs for installed power packs of any of the plurality of machines.

### TECHNICAL FIELD

The present disclosure relates generally to a machine system, and more particularly to interchangeable power packs for a plurality of machines and a power pack loading system.

### BACKGROUND

A variety of machinery systems are in widespread use throughout the world for all manner of applications including construction, mining, material handling, and still others. Machinery systems typically employ numerous different types of machines for large scale projects, including loaders, track-type tractors, scrapers, handlers, motor graders, hauling machines such as trucks, and many others. Such machinery systems have traditionally been powered by way of internal combustion engines onboard each machine.

In recent years, increased engineering and commercial efforts have been directed toward developing heavy-duty machinery that is at least in part electrically powered. Batteries, fuel cells, and generator sets or “gensets” have begun to take the place of traditional internal combustion engines in various applications. Different power supplies may be suited for different applications. For instance, in some environments internal combustion engines remain highly desirable due to plentiful, economically available, and energy-dense liquid fuels. In other instances, electrically powered machines may be highly desirable due to various regulatory requirements.

In many instances, a worksite can be remote from an electrical grid, thus maintaining and replenishing battery charge can require idling machines for recharging. These and other challenges have limited certain electric power applications from more widespread adoption. Some manufacturers have experimented with replaceable batteries that can be exchanged from a machine when depleted for a fresh battery. Handling relatively large batteries can be unwieldly and potentially create risks for personnel on the ground. Moreover, simply replacing batteries for depleted machines can limit flexibility in utilizing different types of power supplies. One example machine system where machines and battery changes are proposed is set forth in U.S. Pat. No. 8,983,657 to Jacobson. The art provides ample opportunities for improvements and/or development of alternative strategies.

### SUMMARY

In one aspect, a machine system includes a plurality of machines each having a machine frame, ground-engaging propulsion elements, an electrical power system, an electrical input connector, and a power pack installation station including first power pack guide elements. The machine system also includes a plurality of power packs each having an electrical power supply, and an electrical output connector, and interchangeable for installation on any respective one of the power pack installation stations. The machine system further includes a power pack loading system having a system frame, and a power pack swapping station including second power pack guide elements. The plurality of machines are each positionable at a service location relative to the power pack loading system aligning the first power pack guide elements with the second power pack guide elements, for translated transfer of any one of the plurality of power packs between the power pack loading system and any one of the plurality of machines.

In another aspect, a method of operating a machine system includes positioning a mobile machine at a service location relative to a power pack loading system, and electrically disconnecting an electrical power system of the mobile machine from an electrical power supply of an installed power pack on a power pack installation station of the mobile machine. The method further includes swapping the installed power pack for a replacement power pack on a power pack swapping station of the power pack loading system, and guiding outgoing translational motion of the installed power pack and incoming translational motion of the replacement power pack during the swapping the installed power pack for the replacement power pack. The method further includes electrically connecting the electrical power system of the mobile machine to an electrical power supply of the replacement power pack.

In still another aspect, a machine system includes a power pack having a power pack housing forming a storage compartment, at least one of a genset, a battery, or a fuel cell within the storage compartment, an electrical output connector, an access door to the storage compartment adjustable between a closed configuration and an open configuration, and a plurality of guide rail-engagement surfaces. The machine system further includes a power pack loading system having a system frame, and a power pack swapping station including a guide rail for guiding translational motion of a power pack via contact with the plurality of guide rail-engagement surfaces. The power pack loading system further includes a station actuator for varying at least one of a height or an angular orientation of a power pack swapping station relative to an axis.

### BRIEF DESCRIPTION OF DRAWINGS

FIG. 1 is a diagrammatic view of a machine system in one configuration, according to one embodiment;

FIG. 2 is a diagrammatic view of a machine system in a second configuration, according to one embodiment;

FIG. 3 is a diagrammatic view of a power pack loading system, according to one embodiment;

FIG. 4 is a diagrammatic view of a group of machines, according to one embodiment;

FIG. 5 is a diagrammatic view of a machine system, according to one embodiment; and

FIG. 6 is a diagrammatic view of portions of a machine system, according to one embodiment.

### DETAILED DESCRIPTION

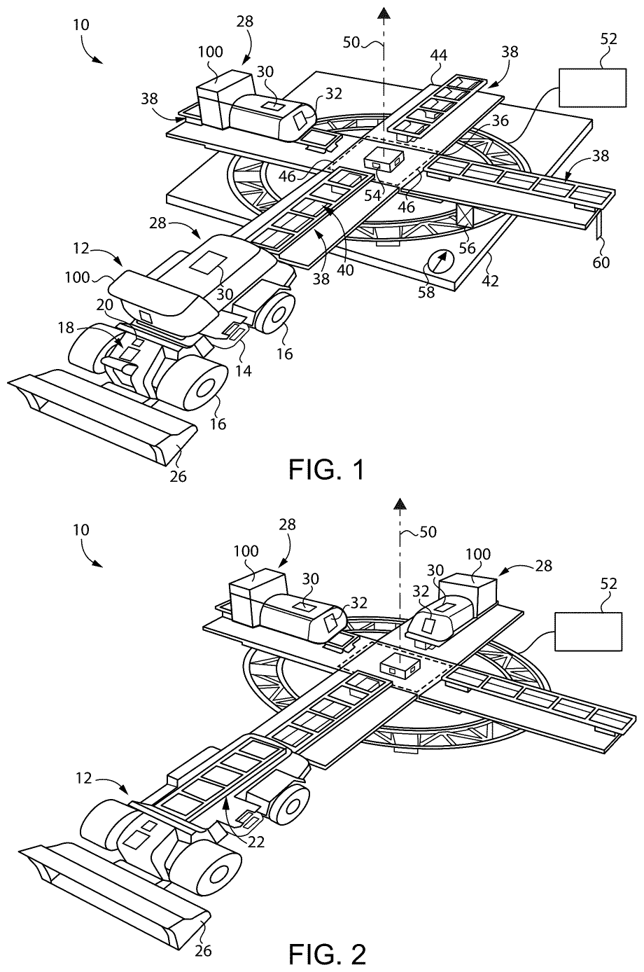

Referring to FIGS. 1 and 2, there is shown a machine system 10, according to one embodiment. Machine system 10 includes a machine 12 having a machine frame 14, ground-engaging propulsion elements 16. In a practical implementation machine system 10 may include a plurality of different machines potentially varying as to design, application, and customization, as will be further apparent from the following description. Accordingly, description or discussion herein of a machine in the singular, or machines in the plural, can be understood to refer by way of analogy to any one or more machines in machine system 10 except as where otherwise indicated or apparent from the context. Machine system 10 could be applied in the context of mining, construction, earthmoving, landfill operations, forestry, or materials or inventory management, to name a few examples.

Machine 12 includes an electrical power system 18, an electrical input connector 20, and a power pack installation station 22 having first power pack guide elements 24. In the illustrated embodiment, machine 12 includes an implement 26 in the nature of a bucket. Other machines in machine system 10 could include different implements such as blades, rippers, dump beds, lifting forks, and still others. Electrical power system 18 can include one or more electric motors, including one or more electric traction motors and other motors for additional equipment such as a hydraulic implement pump. Electrical power system 18 may also include or be connected to heating, cooling, and ventilation equipment for an operator, control systems and communication systems, sensors, and various other electrically powered devices.

Machine system 10 further includes a plurality of power packs 28 each having an electrical power supply 30, and an electrical output connector 32. In an embodiment electrical output connector 32 might be positioned on a bottom or belly or a power pack 28, with electrical connection for charging and/or discharging of the respective power pack being made at a bottom surface thereof. Electrical output connector 32 is arranged to connect to electrical input connector 20 when a power pack 28 is installed on machine 12. Electrical power supply 30 may include at least one of a genset, a battery, or a fuel cell. In one implementation, among the plurality of power packs 28 at least some power packs include different ones of a genset, a battery, or a fuel cell. Thus, some of the power packs may differ from one another respecting their particular power supply, although the present disclosure is not thereby limited and all power supplies might be the same in some instances. Power packs 28 are interchangeable for installation on any one of a plurality of power pack installation stations 22 of a plurality of machines 12 in machine system 10. Interchangeable for installation means any power pack 28 can be used with any one machine and is physically structured and electrically structured for service in any power pack installation station 22. Thus, embodiments are contemplated where one machine can operate using a first power pack having a genset or a second power pack having a fuel cell. Flexibility in use of different, but interchangeable, power packs for each machine can enable machines to be powered based upon various differing considerations at a worksite, such as fuel availability and/or cost, or local requirements as to emissions. In one example, a machine can be equipped with a genset where appropriate to utilize an internal combustion engine to provide electrical power. In another instance the machine can be used with a fuel cell for providing electrical power. Still other variations are possible within the scope of the present disclosure, such as power packs including gensets that operate on a first fuel type such as diesel and power packs including gensets that operate on a second fuel type such as gaseous hydrogen fuel.

Machine system 10 further includes a power pack loading system 34 having a system frame 36, and a power pack swapping station 38 having second power pack guide elements 40. Loading system 34 may also include a base frame 42. Embodiments are contemplated where base frame 42 has a structure similar or identical to structures used in certain known types of off-highway equipment, such as a hydraulic excavator that is capable of rotation around a vertical axis. In the illustrated embodiment loading system 34 defines a central axis 50. Central axis 50 may be a vertical axis or a horizontal axis, for example. Loading system 34 may also include a plurality of wings 44 extending from a central structure or platform 48. Wings 44 may be foldable, vertically upward, at fold lines 46 to position loading system 34 in a configuration for transport. Embodiments are contemplated where base frame 42 includes or is placed upon a trailer or directly on a truck. In such an embodiment, loading system 34 can be transitioned between a service configuration, approximately as shown, and a transport configuration where wings 44 are folded upward.

Loading system 34 may also include or be connected to an electrical power supply 52. Electrical power supply 52 could include a genset or a local or regional electrical power grid, or potentially a fuel cell installation or a renewable energy installation having wind turbines and battery storage, to name a few examples. Electrical power supply 52 may be electrically connected to a plurality of electrical power charging conduits 54 that can be connected to electrical output connectors 32 of power packs 28 resident on loading system 34 for charging. Machine 12, and by analogy a plurality of machines, is positionable at a service location relative to loading system 34 aligning first power pack guide elements 24 with second power pack guide elements 40, for translated transfer of any one of power packs 28 between loading system 34 and any one of the plurality of machines 12.

Also in the illustrated embodiment, loading system 34 includes a carousel rotatable about axis 50 and having a plurality of power pack swapping stations 38 positioned upon wings 44 at circumferentially spaced locations about axis 50. It will be recalled axis 50 may be a vertical axis or a horizontal axis. Thus, a carousel as contemplated herein could be a carousel rotated about a vertical axis or a carousel rotated about a horizontal axis. Description and discussion herein of a vertical axis or a vertical direction are not to be understood as limiting, and thus refer by way of analogy to a horizontal axis or a horizontal direction or even a diagonal axis or a diagonal direction. It can thus be appreciated that a plurality of machines 12 can be periodically positioned at one or more service locations for swapping a discharged or otherwise at least partially spent power pack 28 for a fresh, charged power pack. As suggested above, loading system 34 is configured for aligning power pack guide elements 24 and 40 to enable translated transfer for swapping power packs. Translated transfer means by way of translational motion of any installed power pack and translational motion of a replacement power pack 38. Outgoing translational motion of an installed power pack 38 from a machine, and incoming translational motion of a replacement power pack 38 to the machine, during swapping the two can be guided by way of first power pack guide elements 24 and second power pack guide elements 40 as further discussed herein.

As also noted above, loading system 34, in this example configured as a carousel, includes electrical charging conduits 54 structured to couple to a plurality of power packs 38 resident on the plurality of power pack swapping stations 38. It will be noted that in FIG. 1 machine 12 is shown as it might appear with a power pack 28 installed on power pack installation station 22. Another, replacement power pack 28 is shown supported on one of wings 44. The installed power pack 38 can be offloaded from machine 12 onto an empty power pack swapping station 38, and loading system 34 rotated to position the replacement power pack 28 for installation. To this end, loading system 34 may include a pump 58 structured to operate a hydraulic motor actuator 56 that rotates wings 44 around vertical axis 50 to position power packs 28 for swapping. Each of wings 44 may be equipped with an outrigger or the like 60 that extends into contact with a substrate for supporting the respective wing 44. Also in the illustrated embodiment, each power pack 28 is coupled to an operator cab 100, so as to form a plurality of pack and cab assemblies. In other embodiments power packs 28 are not coupled with a cab, and the cabs remain on the machines, or the machines may not have cabs at all such as in certain autonomous machine systems. It will be appreciated that positioning of any machine for swapping power packs, as well as the swapping procedure discussed herein may occur autonomously.

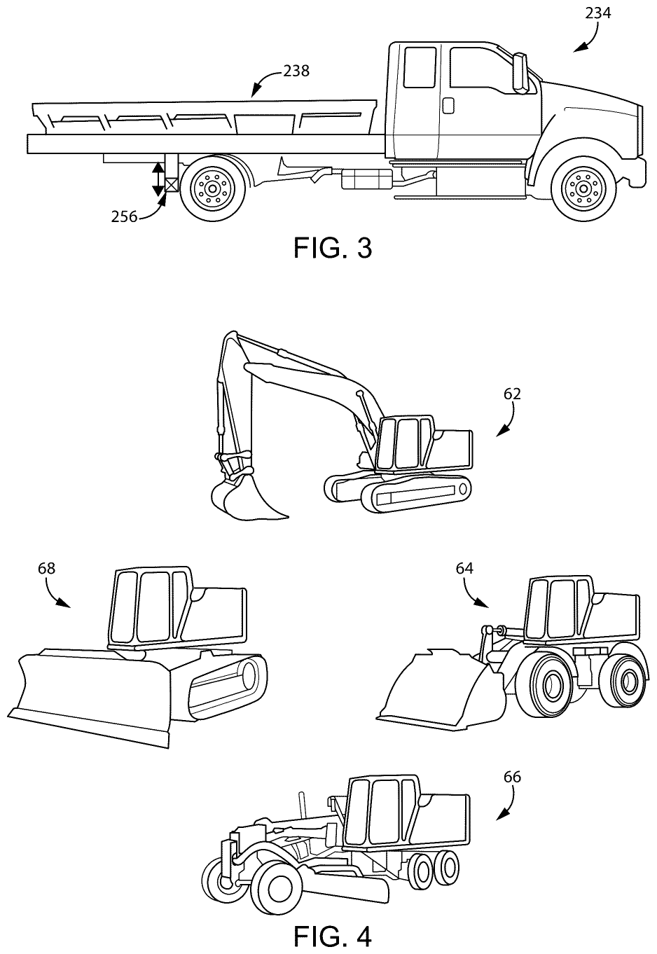

Turning now to FIG. 3, there is shown a power pack loading system 234 according to another embodiment. Power pack loading system 234 may include a number of similarities to power pack loading system 34 discussed above, but certain differences. Loading system 234 includes a power pack swapping station 238. In contrast to the carousel arrangement of loading system 34, in loading system 234 only a single power pack installation station is provided and mounted on a mobile vehicle. Loading system 234 may also include a lift actuator 256 that can raise or lower power pack swapping station 238 to a service location to align power pack guide elements of swapping station 238 with power pack guide elements of a power pack. It can be appreciated that loading system 234 could be mobile and configured to deliver a fresh power pack to a machine in the field, or retrieve a depleted power pack from a machine in the field. Embodiments are contemplated where two loading systems 234 would be dispatched to retrieve a depleted power pack and provide a fresh power pack to a single machine. In other instances, one of an installed power pack or a replacement power pack could be handled by way of other machinery and loading system 234 used only for power pack delivery or retrieval. In still other instances, loading system 234 could be equipped with a carousel power pack loading system as contemplated herein, for example, a carousel power pack loading system having two, three, four, five, or six or more power pack swapping stations.

Turning now to FIG. 4, there are shown a plurality of different machines each with an installed power pack that could be used in machine system 10. FIG. 4 shows a hydraulic excavator 62, a wheel loader 64, a motor grader 66, and a track type tractor 68. It should also be appreciated that the type and number of machines in machine system 10 are essentially limitless. In some applications, literally dozens of machines and dozens of power packs could be part of machine system 10 with the many different machines operating with the power packs swapping back and forth between a loading station and the machines themselves while the power packs are recharged on the loading station. In some embodiments, multiple different loading stations could be deployed at a large-scale work site. Still other applications contemplate substantially identical and interchangeable machines of any number in machine system 10. For instance, all of a plurality of machines in machine system 10 could be wheel loaders, handlers, tractors, hauling machines, or still others.

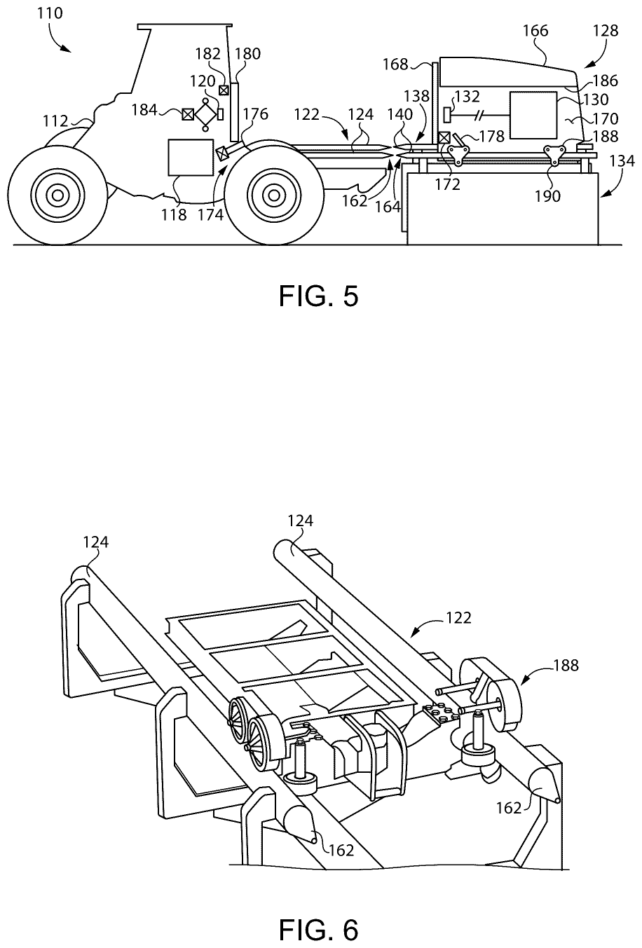

Turning now to FIG. 5, there is shown a machine system 110 similar to machine system 10 discussed above, and illustrating certain details of a machine 112 and a power pack loading system 134. Machine 112 is shown for illustration as a wheeled machine capable of coupling with a variety of different types of implements and including a power pack installation station 122. Power pack loading system 134 includes a power pack swapping station 138. Power pack installation station 122 includes first guide elements 124. In the illustrated embodiment, guide elements 124 include two parallel rails, and guide elements 140 of power pack swapping station 138 also include two parallel rails. Guide elements or rails 124 include rail tips 162. Guide elements or rails 140 include rail tips 164. In can be appreciated that rail tips 162 and 164 may be tapered as shown, allowing alignment at a service location with some tolerance for misalignment and transfer of a power pack 128 between installation station 122 and swapping station 138. Loading system 134 may include a carousel loading system as in loading system 34, although the present disclosure is not thereby limited.

Still focusing on FIG. 5, machine system 110 may include a power pack latching mechanism 174. Across an entirety of machine system 110 a plurality of power pack latching mechanisms may be used, and each located in part on each respective one of a plurality of power packs 128 and each one of a plurality of machines 112. In the illustrated embodiment, latching mechanism 174 includes an actuator pin 176, on machine 112, and an apertured plate 178, on power pack 128, arranged to receive actuatable pin 176 at a latching position extending through an aperture.

It can thus be appreciated that power pack 128 can be installed on installation station 128 and pin 176 operated to pass through an apertured plate 178 to lock power pack 128 in place. Typically, a plurality of actuatable pins will be used to couple to a plurality of apertured plates such as one pin on each of a left and a right side of installation station 122. Still other arrangements could position a pin, or a plurality of pins, on a power pack itself, and place apertured plates on the machine. Other types of latching mechanisms, such as hooks, clamps, or any known suitable device for positively locking a power pack in place and selectively unlocking the power pack could be used within the scope of the present disclosure. In at least some embodiments, all of the machines in a machine system according to the present disclosure will be equipped with at least part of a latching mechanism to secure a power pack, and a power pack loading system also equipped with at least part of a latching mechanism to secure a power pack. In this way power packs can be securely latched both for service on a machine and for charging and availability for service on a power pack loading system.

Each of a plurality of power packs 128 in machine system 110 may further include a housing 166 forming a storage compartment 170 wherein an electrical power supply 130 as discussed herein is positioned. Electrical power supply 130 may be connected to an electrical output connector 132. As discussed in connection with other embodiments, electrical power supply 130 may include at least one of a genset, a battery, or a fuel cell. Power pack 128 may also include a movable access door 168 of housing 166 providing access to storage compartment 170. As noted, electrical power supply 130 and electrical output connector 132 may be within storage compartment 170. Power pack 128 may also be provided with a door actuator 172 that opens access door 168, such as by sliding upward and downward to open and close storage compartment 170. Access door 168 might alternatively swing, fold, or roll up and down, for example.

Machine 112 may also be equipped with an access door 180, sliding upward and downward, for example, coupled to a door actuator 182. In the illustrated embodiment machine 112 includes an electrical connector actuator 184. When access door 180 is open, actuator 184 can operate to advance an electrical input connector 120 to engage with electrical output connector 132. FIG. 5 also shows a lifting fork pickup structure 186 of power pack 128. Lifting fork pickup structure 186 may be one of two such structures positioned at opposite sides of power pack 128, and one hidden from view in FIG. 5. A service machine, such as a lifting fork can lift and position power pack 128 for installation or removal from a machine, or for positioning upon a loading station as discussed herein. Lifting fork pickup structure 186 may include one or more horizontal surfaces, ledges, lifting eyes, or other structures of housing 166, or combinations of these.

Referring also now to FIG. 6, there are shown portions of some features depicted in FIG. 5 in further detail. As discussed above, swapping station 122 can include guide elements in the form of a set of rails 124. FIG. 6 also depicts portions of power pack 128 also shown in FIG. 5 and including wheels 188. Wheels 188 can include carry wheels that support a weight of power pack 128 as it rolls between the aligned installation station 122 and swapping station 138. Power pack 128 may also include rail anti-disengagement wheels 190. As can be seen from FIG. 6 power pack 128 can be equipped with carry wheels 188, wheels restricting lateral movement (not numbered), and wheels preventing vertical and/or horizontal movement to prevent undesired disengagement. It can further be appreciated that wheels 188 form a plurality of guide rail-engagement surfaces, corresponding to outer surfaces of wheels 188. Loading system 138 may include at least one guide rail 138 that contacts wheels 188 and their guide rail-engagement surfaces. In other embodiments, it is contemplated that power pack swapping could occur without the use of wheels at all, providing lubricated surfaces enabling a power pack to slide between an installation station and a swapping station.

### INDUSTRIAL APPLICABILITY

Referring to the drawings generally, operating a machine system according to the present disclosure, such as machine system 10, machine system 110, can include positioning a mobile machine at a service location relative to a power pack loading system. At the service location, an electrical power system of the mobile machine can be electrically disconnected from an electrical power supply of an installed power pack on a power pack installation station of the machine. With the electrical connections disconnected, typically when the respective access doors are open, the installed power pack can be swapped for a replacement power pack on a power pack swapping station of the power pack loading system. Outgoing translational motion of the installed power pack and incoming translational motion of the replacement power pack can be guided during the swapping by way of a rail system or another suitable system as discussed herein. It will be appreciated that one or more latching mechanisms coupling a power pack to a machine can be disengaged to enable the transfer. Once a replacement power pack is suitably positioned on an installation station, the electrical power system of the machine can be electrically connected to the electrical power supply of the replacement power pack.

Many work environments are quite dusty, thus when a power pack is disengaged from a machine the access door may be closed to prevent entry of debris. In some instances, if a machine is idled waiting for a replacement power pack, the access door of the idled machine may also be closed until such time as the replacement power pack is to be electrically connected. As also discussed above, in at least some embodiments positioning of a mobile machine at a service location can include driving a mobile machine to a location in proximity to a loading system, and rotating a carousel to position guide elements of a power pack swapping station in alignment with guide elements of a power pack installation station. As also discussed above, electrical power supplies of replacement power packs can be charged while on the loading station. Where gensets are used, a fuel tank for an engine in a genset could be refueled also on the loading station.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A machine system comprising:
a plurality of machines each including a machine frame, ground-engaging propulsion elements, an electrical power system, an electrical input connector, and a power pack installation station including first power pack guide elements;
a plurality of power packs each including an electrical power supply, and an electrical output connector, and interchangeable for installation on any one of the power pack installation stations;
a power pack loading system including a system frame, and a power pack swapping station including second power pack guide elements; and
the plurality of machines are each positionable at a service location relative to the power pack loading system aligning the first power pack guide elements with the second power pack guide elements, for translated transfer of any one of the plurality of power packs between the power pack loading system and any one of the plurality of machines.

2. The machine system of claim 1 wherein the power pack loading system includes a carousel rotatable about an axis and having a plurality of power pack swapping stations arranged at circumferentially spaced locations about the axis.

3. The machine system of claim 2 wherein the carousel further includes a plurality of electrical charging conduits structured to couple to a plurality of power packs resident on the plurality of power pack swapping stations.

4. The machine system of claim 1 wherein the first power pack guide elements include a first set of rails, and the second power pack guide elements include a second set of rails.

5. The machine system of claim 4 wherein each of the plurality of power packs includes carry wheels and rail anti-disengagement wheels.

6. The machine system of claim 5 further comprising plurality of a power pack latching mechanisms.

7. The machine system of claim 6 wherein each respective power pack latching mechanism includes an actuatable pin, and an apertured plate arranged to receive the actuatable pin at a latching position.

8. The machine system of claim 1 wherein each of the plurality of power packs includes a housing having a movable access door to a storage compartment, and wherein the electrical power supply and the electrical output connector are within the storage compartment.

9. The machine system of claim 8 further comprising an actuator for moving one of the electrical input connector or an associated said electrical output connector into engagement with the other of the electrical input connector or the associated said electrical output connector.

10. The machine system of claim 1 wherein each of the plurality of power packs includes a lifting fork pickup structure.

11. The machine system of claim 1 wherein the electrical power supply of each of the plurality of power packs includes at least one of a genset, a battery, or a fuel cell, and among the plurality of power packs at least some include different ones of a genset, a battery, or a fuel cell.

12. The machine system of claim 1 wherein each of the plurality of power packs is attached to an operator cab so as to form a plurality of pack and cab assemblies.

13. A method of operating a machine system comprising:
positioning a mobile machine at a service location relative to a power pack loading system;
electrically disconnecting an electrical power system of the mobile machine from an electrical power supply of an installed power pack on a power pack installation station of the machine;
swapping the installed power pack for a replacement power pack on a power pack swapping station of the power pack loading system;
guiding outgoing translational motion of the installed power pack and incoming translational motion of the replacement power pack during the swapping the installed power pack for the replacement power pack; and
electrically connecting the electrical power system of the mobile machine to an electrical power supply of the replacement power pack.

14. The method of claim 13 wherein the positioning the mobile machine at the service location includes rotating a carousel of the power pack loading system to position guide elements of the power pack swapping station in alignment with guide elements of the power pack installation station.

15. The method of claim 14 further comprising charging the electrical power supply of the replacement power pack on the carousel.

16. The method of claim 13 wherein the guiding further includes guiding the outgoing translational motion and the incoming translational motion via guide rails of both the power pack installation station and the power pack swapping station.

17. The method of claim 13 further comprising opening a door on at least one of the replacement power pack or the mobile machine, and wherein the electrically connecting the electrical power system includes establishing an electrical connection through the opened door.

18. A machine system comprising:
a power pack including a power pack housing forming a storage compartment, at least one of a genset, a battery, or a fuel cell within the storage compartment, an electrical output connector, an access door to the storage compartment adjustable between a closed configuration and an opened configuration, and a plurality of guide rail-engagement surfaces;
a power pack loading system including a system frame, and a power pack swapping station including a guide rail for guiding translational motion of the power pack via contact with the plurality of guide rail-engagement surfaces; and
the power pack loading system further including a station actuator for varying at least one of a height or an angular orientation of the power pack swapping station relative to an axis.

19. The machine system of claim 18 wherein the power pack further comprises:
a connector actuator within the storage compartment and coupled to the electrical output connector so as to advance the electrical output connector from the storage compartment through the opened access door; and
carry wheels and rail anti-disengagement wheels.

20. The machine system of claim 18 wherein:
the power pack is one of a plurality of power packs interchangeable for installation on a plurality of machines; and
the power pack loading system includes a carousel, and the power pack swapping station is one of a plurality of power pack swapping stations on the carousel at a plurality of different angular orientations about the axis.
